(19) United States
(12) Patent Application Publication
(10) Pub. No.: US 2011/0063081 A1
(43) Pub. Date: Mar. 17, 2011

(54) ANTENNA DEVICE FOR RF TAG COMMUNICATION AND RF TAG READER AND WRITER

(75) Inventor: Kouichi Sano, Shizuoka-ken (JP)

(73) Assignee: TOSHIBA TEC KABUSHIKI KAISHA, Tokyo (JP)

(21) Appl. No.: 12/874,490

(22) Filed: Sep. 2, 2010

(30) Foreign Application Priority Data
Sep. 15, 2009 (JP) 2009-213086

(51) Int. Cl. G06K 7/01; H01Q 1/42

(52) U.S. Cl. 340/10.1; 343/872

(57) ABSTRACT

There is provided an antenna device for RF tag communication including: a plate-shaped radiation element; and an antenna case body which contains the radiation element and has an indicating unit at a position corresponding to a region in which the field intensity of the electric field generated at the radiation element is the highest.

### CROSS-REFERENCE TO RELATED APPLICATION(S)

This application is based upon and claims the benefit of priority from Japanese Patent Application No, 2009-213086, filed on Sep. 15, 2009; the entire contents of which are incorporated herein by reference.

### FIELD

The embodiments described in this specification relate to an RF tag reader and writer for communicating with an RF tag in a non-contact manner and to an antenna thereof.

### BACKGROUND

The RFID (Radio Frequency Identification) system is attracting attention and is being introduced in the field of distribution, for example. The RFID system includes an IC chip and an antenna, and is constituted by an RF tag (also referred to as a wireless tag or an RFID tag) attached to respective goods and an RF tag reader and writer (hereinafter, also simply referred to as a reader and writer) for reading information stored in a memory within the IC chip of the RF tag in a non-contact manner and writing information in the memory within the IC chip of the RF tag in a non-contact manner.

As a process by the RFID system, a collective information reading process from a plurality of RF tags (hereinafter, referred to as a collective reading) in an inventory count in a shop or the like can be exemplified. At this time, the reader and writer radiates radio waves in a range of up to several meters, executes communications with unspecified RF tags each of which is attached to each of a plurality of commercial goods, and collectively reads the information stored in the respective RF tags. In addition, as other processes by the RFID system, it is possible to exemplify reading and writing processes with respect to one or a plurality of specific RF tags (hereinafter, both of which are referred to as selective reading and selective writing, respectively, and referred to as selective communication, collectively). At this time, the reader and writer selectively reads information from specific RF tags or selectively writes information in the RF tags.

Here, there are cases where selective writing or the like is performed in the circumstances of a shop or the like, around which a number of commercial goods attached with the RF tags exist. In such circumstances, information may be written to an RF tag different from an RF tag to which a user desires to write the information, as a result of the communication with circumferential RF tags by mistake. Accordingly, in the conventional technique, the user was required to use both a reader and writer for a collective reading and a reader and writer for a selective communication, which has a smaller radio wave transmission output than that of the reader and writer for collective reading and has a narrower range of directionality, depending on the operation. In addition, when performing selective communication, the user was required to perform an action such as keeping RF tags which were not communication targets away from the circumference of the antenna device of the reader and writer.

### BRIEF DESCRIPTION OF THE DRAWINGS

FIG. 1 is a perspective view of an RF tag reader and writer of a first embodiment;

FIG. 2 is a block diagram illustrating a hardware configuration of the RF tag reader and writer of the first embodiment;

FIG. 3 is a circuit configuration diagram of a wireless unit included in the RF tag reader and writer of the first embodiment;

FIG. 4 is a sectional view of an antenna device taken along a line A-A′ in FIG. 1;

FIG. 5 is a plan view of a radiation element and a feeding point according to the first embodiment;

FIG. 6 is a graph for illustrating a distribution of field intensity in the first embodiment;

FIG. 7 is a graph for illustrating a distribution of field intensity in the first embodiment;

FIG. 8 is a diagram illustrating a process flow relating to a communication with an RF tag in the first embodiment;

FIG. 9 is a diagram illustrating an example of a process designation screen in the first embodiment;

FIG. 10 is a diagram illustrating an example of a result notification screen in the first embodiment;

FIG. 11 is a diagram illustrating an example of an RF tag arrangement designation screen in the first embodiment;

FIG. 12 is a diagram illustrating an example of a result notification screen in the first embodiment;

FIG. 13 is a diagram illustrating an example of a result notification screen in the first embodiment;

FIG. 14 is a perspective view of an antenna device with a restriction member mounted thereon according to a second embodiment; and

FIG. 15 is a perspective view of an antenna device according to another embodiment.

### DETAILED DESCRIPTION

### First Embodiment

According to a first embodiment, the RF tag reader and writer includes an antenna device for RF tag communication and a transmission output control unit. The antenna device for RF communication includes a plate-shaped radiation element and an antenna case body which accommodates the radiation element and has an indicating unit at a position corresponding to a region in which the field intensity of the electric field generated by the radiation element reaches its highest. In addition, the transmission output control unit controls the transmission output of the radio wave radiated from the radiation element.

Hereinafter, the description will be made of the embodiment with reference to the drawings. The following description will be made while exemplifying an identification ID as the information to be read from or written to the RF tags. In addition, the description will be made while exemplifying as a collective communication a collective reading to be used in operations such as an inventory count and the like.

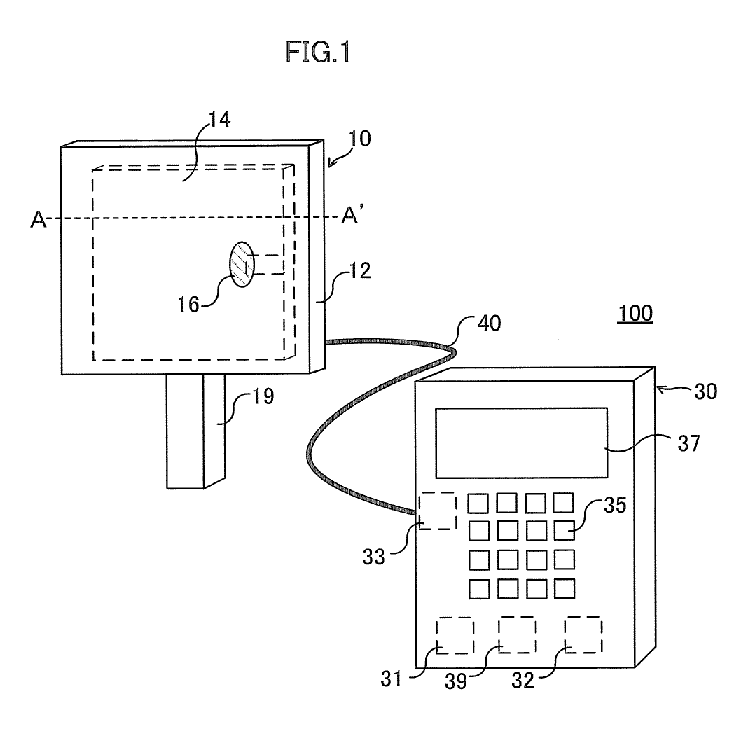

FIG. 1 is a perspective view illustrating a schematic configuration of an RF tag reader and writer 100 according to the first embodiment. The reader and writer 100 of the first embodiment includes an antenna device 10 and a reader and writer main body 30. The antenna device 10 and the reader and writer main body 30 are connected by a coaxial cable 40. The antenna device 10 includes an antenna case body 12 and a patch antenna 14 accommodated in the case body. The reader and writer 100 communicates with RF tags (not illustrated) via radio waves radiated from the patch antenna.

In the first embodiment, an indicating unit 16 is provided on the outer surface of the case body 12 of the antenna device. In addition, in the first embodiment, the reader and writer 100 has a communication mode relating to selective reading and selective writing, in which the reader and writer can communicate with the RF tags only in the region indicated by the indicating unit 16, and a communication mode relating to collective reading in which the reader and writer can communicate with the RF tags in a broader range than that for the former communication mode.

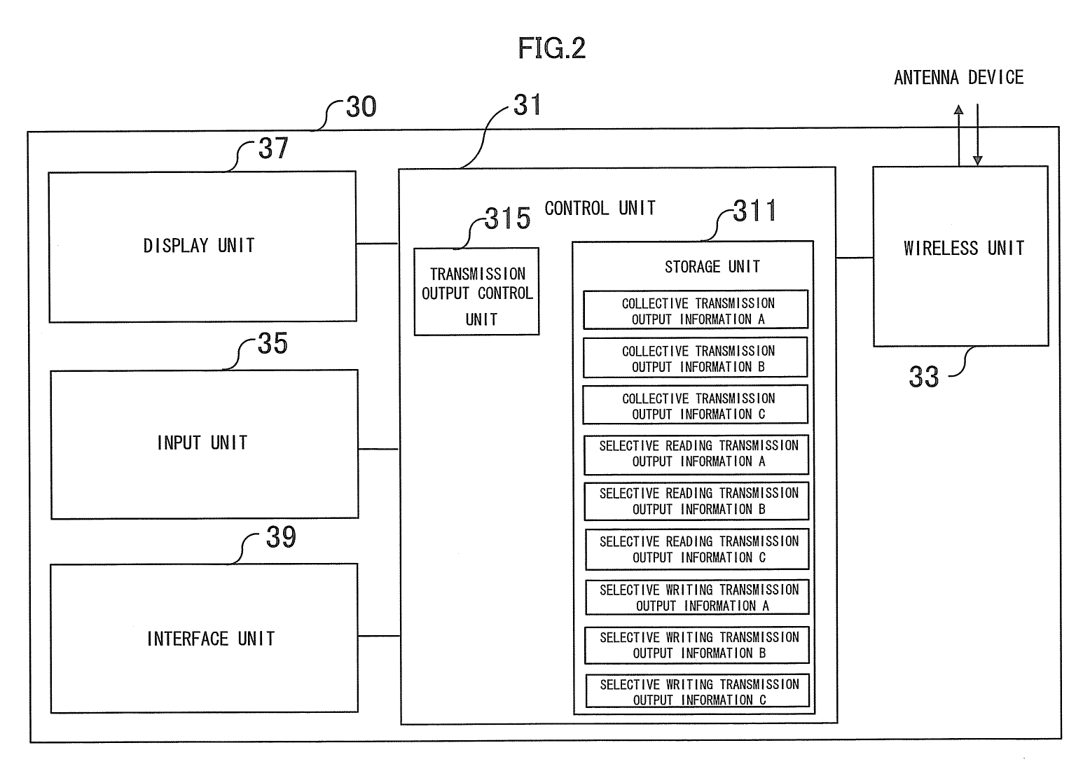

First, the description will be made of a configuration of hardware provided in the reader and writer main body 30. As shown in FIG. 2, the reader and writer main body 30 includes a control unit 31, a wireless unit 33, an input unit 35, a display unit 37, and an interface unit 39. In addition, a power source unit 32, which controls a battery and the charge and discharge thereof, shown in FIG. 1 supplies a current to each hardware and the antenna device 10. Accordingly, the reader and writer 100 of the first embodiment is configured as a mobile reader and writer.

The control unit 31 plays a role in performing various processes in the reader and writer 100, such as communications with the RF tags or communications with external devices such as a personal computer (not illustrated), and the like, via a network, by executing a program stored in a storage unit 311, which will be described later, based on input from a user. For example, the control unit 31 controls the wireless unit 33 in accordance with a communication protocol such that an identification ID obtained by a PC via the interface unit 39 which will be described later or input by the user via the input unit 35 which will be described later is transmitted from the antenna device 10 to the RF tags via radio waves. In addition, the control unit 31 includes the storage unit 311 and a transmission output control unit 315 which will be described later.

The storage unit 311 stores output information as information to be used by the transmission output control unit 315, which will be described later, regarding the magnitude of the transmission output corresponding to one of collective reading, selective reading, and selective writing, in addition to the obtained identification ID and the communication protocol for transmitting the identification ID via radio waves (a communication protocol for RF tags complying with, for example, ISO18000-6).

The transmission output control unit 315 controls the wireless unit 33, which will be described later, to cause the antenna device to radiate radio waves at a transmission output based on the transmission output information stored in the storage unit 311.

Here, according to the first embodiment, the transmission output control unit 315 causes the antenna device 10 to radiate radio waves at a transmission output capable of communicating only with the RF tags positioned in the region indicated by the indicating unit 16 provided in the antenna case body 12 when controlling the wireless unit 33, which will be described later, based on the output information relating to selective reading and selective writing (selective reading output information and selective writing output information) In addition, the transmission output control unit 315 causes the antenna device 10 to radiate radio waves at a transmission output greater than that for selective reading or selective writing when controlling the wireless unit 33 based on the collective reading output information relating to collective reading.

That is, in the first embodiment, the transmission output control unit 315 switches between the communication mode relating to selective reading and selective writing and the communication mode relating to collective reading. In other words, the transmission output control unit can switch between a first output mode for causing the radio wave to be radiated at a transmission output capable of communicating only with the RF tags positioned in the region indicated by the indicating unit and a second output mode for causing radio waves to be radiated at a greater transmission output than that for the first output mode.

Specifically, the control unit 31 of the first embodiment can be configured with a CPU, a RAM, and a ROM mounted on the reader and writer main body 30.

In addition, a suitable value for the transmission output varies depending on the type of the RF tags, and the communication environment where the processes are performed (for example, materials of walls, materials of shelves onto which the RF tags are being mounted, materials of goods to which the RF tags are being attached, the density of the RF tags, and the like) in addition to the process type such as a collective reading and the selective communication. Accordingly, when the transmission output is preset for the respective processes, it is preferable that plural pieces of information are stored for one process, as in the first embodiment, since it is possible to more suitably set the transmission output. If the explanation is made while exemplifying collective reading, three types of output information indicating different transmission outputs of collective reading output information A, B, and C are stored in the first embodiment.

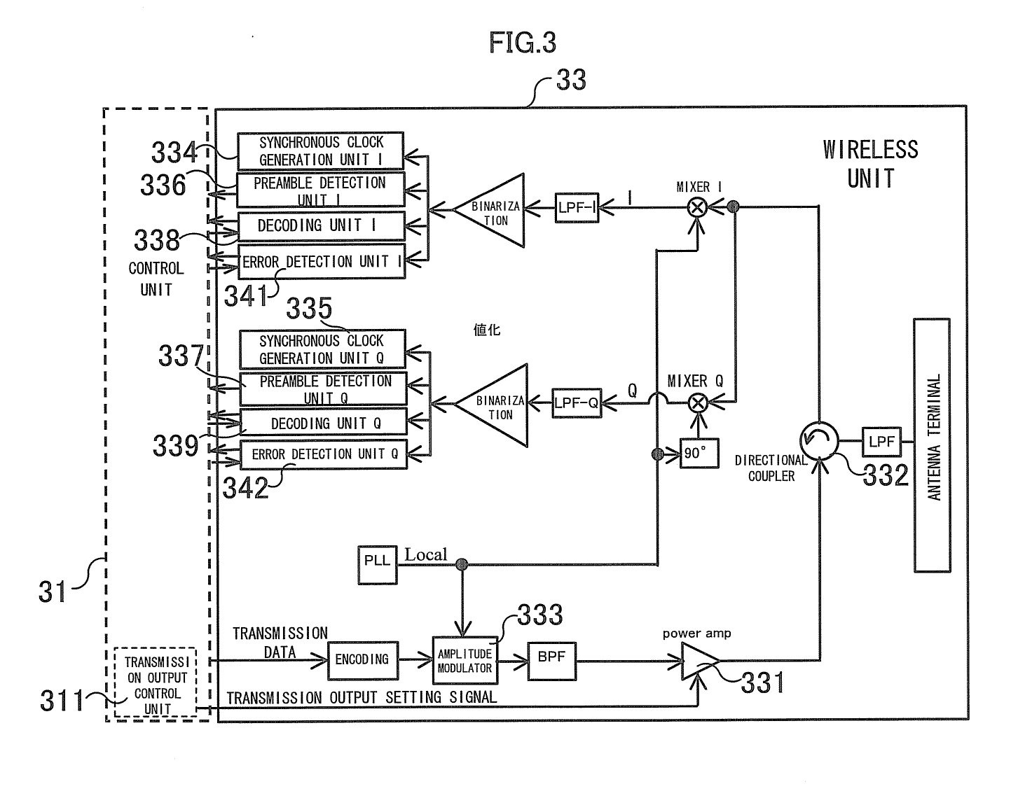

The wireless unit 33 is hardware with a function of communicating with the RF tags via the antenna device 10. FIG. 3 is a detailed circuit configuration diagram of the wireless unit 33.

Here, if the RF tags are passive tags with no battery, the wireless unit 33 first amplifies a non-modulated carrier with a power amplifier 331, outputs radio waves from the antenna via a directional coupler 332, and starts the RF tags. When transmitting data to the RF tags, the wireless unit subjects the signal encoded in accordance with the communication protocol to an amplitude modulation at an amplitude modulator 333, then amplifies the signal with the power amplifier 331, subsequently outputs radio waves from the antenna via the directional coupler 332, and thereby transmits the data. In addition, when a signal is received from the RF tags, the RF tags control (back scatter) impedance at the end of the antenna while the reader and writer 100 is transmitting the non-modulated carrier, thereby the reflection state is changed, and the antenna device of the reader and writer 100 detects the change. The directional coupler 332 performs orthogonal demodulation on the received radio wave signal, and synchronous clock generation units I (334) and Q (335) generate a synchronous clock. Then, preamble detection units I (336) and Q (337) detect a predetermined preamble to thereby detect the head of the data, and decoding units I (338) and Q (339) perform decoding to obtain the received data. In addition, error detection units I (341) and Q (342) are configured to detect the existence of errors using an error detection code. FIG. 3 shows a configuration in which it is determined that the data was appropriately received if there was no error in one of the demodulation of the in-phase component of the orthogonal demodulation and the demodulation of the orthogonal component. In addition, the power amplifier 331 is configured so as to be able to set the transmission output depending on the type of the process based on the control by the transmission output control unit of the control unit 31 (specifically, the transmission of the transmission output setting signal to set the transmission output).

The input unit 35 is hardware through which a user inputs an instruction to the reader and writer 100, and specifically, can be configured with button (keys) capable of inputting instructions by being pressed, a touch pad, and the like.

The display unit 37 is hardware to be used to show the user the result of communication with the RF tags and to encourage the user to input instructions, and specifically, can be configured by an LCD (Liquid Crystal Display) or the like. In addition, the display unit 37 may be configured as a graphical display with a touch panel sensor mounted thereon, and the input unit 35 and the display unit 37 may be integrated.

The interface unit 39 is hardware for communicating with an external device such as a personal computer, which stores an identification ID, via a network.

Next, the description will be made of the antenna device 10 of the first embodiment.

As shown in FIG. 1, the antenna device 10 includes the substantially rectangular antenna case body 12 and the patch antenna 14 accommodated in the antenna case body 12. In the first embodiment, the antenna case body 12 is provided with a grip member 19 for facilitating gripping the antenna device 10 when the user uses the reader and writer 100 while carrying it. However, it is needless to say that the antenna case body 12 can be configured without the grip member 19.

In the first embodiment, the patch antenna 14 can be configured in accordance with a known method, and can be configured to be able to communicate with RF tags only with the indicating unit 16 of the antenna case body 12, as will be described later, and have an antenna gain which receives radio waves radiated to several meters away by adjusting the transmission output.

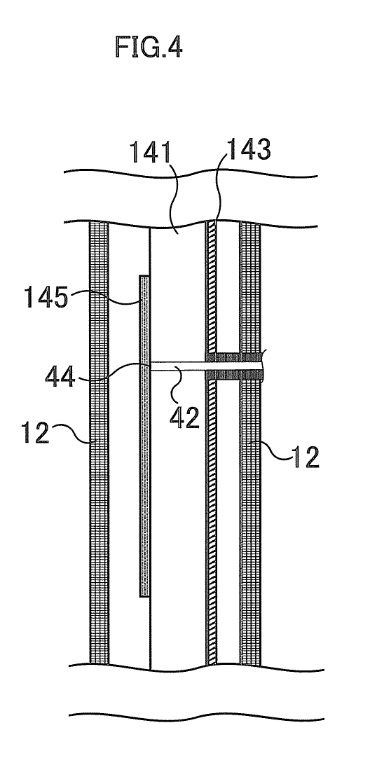

Here, FIG. 4 shows a sectional view of the antenna device 10 taken along a line AA′ line in FIG. 1 for easy understanding of the configuration of the patch antenna 14 of the first embodiment. As shown in FIG. 4, the patch antenna 14 accommodated in the antenna case body 12 includes a dielectric layer 141, a plate-shaped earth conductor 143 facing one main surface of the dielectric layer 141, and a plate-shaped radiation element 145 facing the other main surface of the dielectric layer 141. The earth conductor 143 and the radiation element 145 can be formed using an arbitrary conductive material such as aluminum, copper, or the like. In addition, the dielectric layer 141 can be formed using a dielectric material such as a ceramic, or the like, and can be formed as an air layer.

As shown in FIG. 4, the earth conductor 143 and the dielectric layer 141 are formed with a through hole 42, and the coaxial cable 40 connected to the reader and writer main body 30 is inserted into the through hole 42. The external conductor (GND) of this coaxial cable 40 is connected to the earth conductor 143, and the internal conductor (unbraided wire) is electrically connected to the radiation element 145 on the surface of the radiation element 145, which faces to the dielectric layer 141. In addition, a feeding point 44 is formed at a contact point with the radiation element 145, and the radiation element 145 is supplied with current via the feeding point 44.

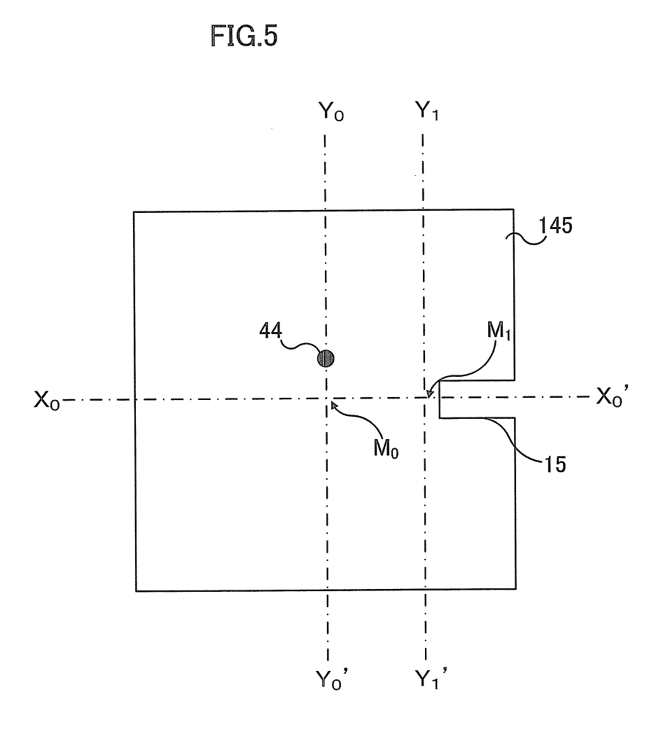

Here, in the first embodiment, the radiation element 145 has a rectangular shape when seen in a plan view as shown in FIG. 5, and a notch portion 15 (slit) is formed at one side of the rectangular plate so as to be recessed toward the center. In addition, the feeding point 44 is positioned at a substantially central position in the extending direction of the notch portion 15 on the plate, and arranged at a position different from a center position M₀ of the plate in the direction perpendicular to the extending direction of the notch portion 15 on the plate.

The notch portion 15 and the feeding point 44 are arranged as described above, and thereby it is possible to generate a region in which the field intensity exceeds a predetermined threshold value t, that is, a region in which the field intensity becomes the maximum, in the vicinity of the leading end of the notch portion (a predetermined position at the notch portion) by adjusting the transmission output of the radio waves. The region is smaller than the region in which the radio waves used for the conventional selective communication propagates, and therefore it is possible to perform a more reliable selective communication with the RF tags by communicating with RF tags in this region.

It is known that in the patch antenna, more current flows in the vicinity of the outer periphery which is parallel to the central axis if the feeding point 44 is formed at a position which is different from the center position M₀ on the central axis of the radiation element when seen in a plan view (corresponding to a part on the X₀-X₀′ line and on the Y₀-Y₀′ line in the radiation element in FIG. 5, for example). In addition, it is also known that more current flows in the vicinity of the end portion of the notch portion which is closest to the center of the radiation element (hereinafter, simply referred to as the leading end of the notch portion) if the notch portion is provided at the outer periphery toward the center of the radiation element. The above operations and effects are obtained by using such characteristics of the patch antenna and changing the transmission output to adjust the range in which the communication with the RF tags is possible.

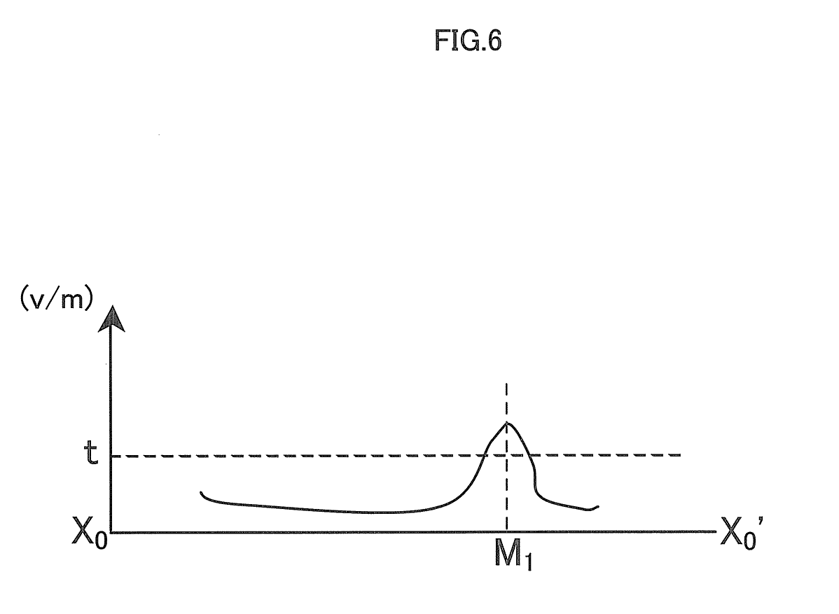

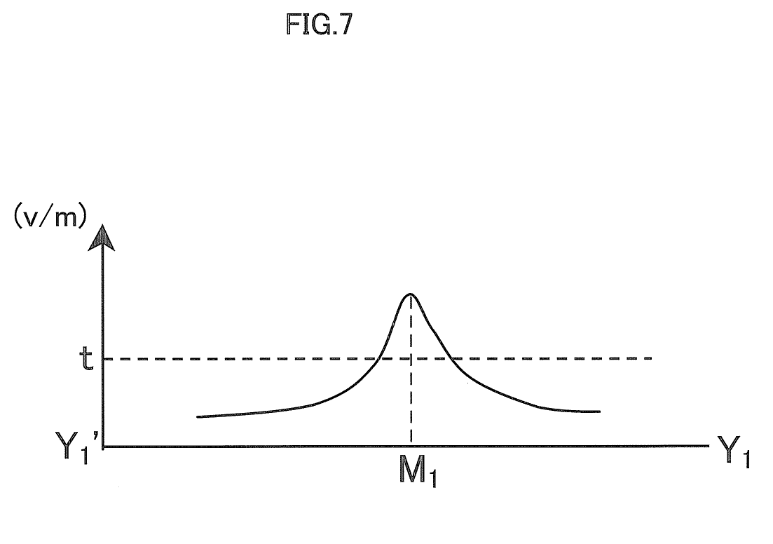

In the first embodiment, the notch portion 15 is formed on one side along the X₀-X₀′ line corresponding to one of the central axes toward the center as shown in FIG. 5, and the feeding point 44 is provided at a position which is different from the center position on the Y₀-Y₀′ line corresponding to the other central axes. FIGS. 6 and 7 show the distributions of the field intensities along the X₀-X₀′ line and the Y₁-Y₁′ line in the first embodiment. As can be understood from FIGS. 5, 6, and 7, the filed intensity is not less than the predetermined threshold value t in the vicinity of the leading end of the notch portion 15 in the first embodiment by providing the notch portion 15 and the feeding point 44 in the above described arrangement. Moreover, the field intensity on the intersection point M₁ between the X₀-X₀′ line and the Y₁-Y₁ line is the maximum.

In addition, although the feeding point 44 and the notch portion 15 are provided at the positions shown in FIG. 5 in the first embodiment, these positions can be appropriately set by those skilled in the art based on the known technique because of the reasons described above. That is, the positions of the notch portion 15 and the feeding point 44 are not limited to the positions shown in FIG. 5, and may be set differently. Similarly, the number and the size (dimension) of the notch portion 15 can be also appropriately set by those skilled in the art based on the known technique.

The threshold value t of the field intensity can be appropriately set by those skilled in the art in accordance with the type, and the like, of the RF tags to be used.

Next, a description will be made of the antenna case body 12. In the first embodiment, the antenna case body 12 is configured as a rectangular compact having a sufficient volume to accommodate the patch antenna 14. In addition, the antenna case body 12 is provided with an elliptical indicating unit on its outer surface, and the elliptical indicating unit corresponds to the vicinity of the leading end of the notch portion 15 which is provided in the radiation element 145 of the patch antenna 14 accommodated therein. In other words, the indicating unit 16 indicates the position corresponding to the vicinity of the leading end of the notch portion 15.

Here, in the first embodiment, the field intensity can be set to be no less than the predetermined threshold value only in the vicinity of the leading end of the notch portion 15 by adjusting the transmission output of the radio waves, and as a result, the setting can be made such that the communication with the RF tags is possible only in the vicinity of the leading end, as described above. Accordingly, the user can easily recognize the region in which the communication with the RF tags is possible in selective communication by providing the indicating unit 16, which indicates the position corresponding to the vicinity of the leading end of the notch portion 15, in the antenna case body 12.

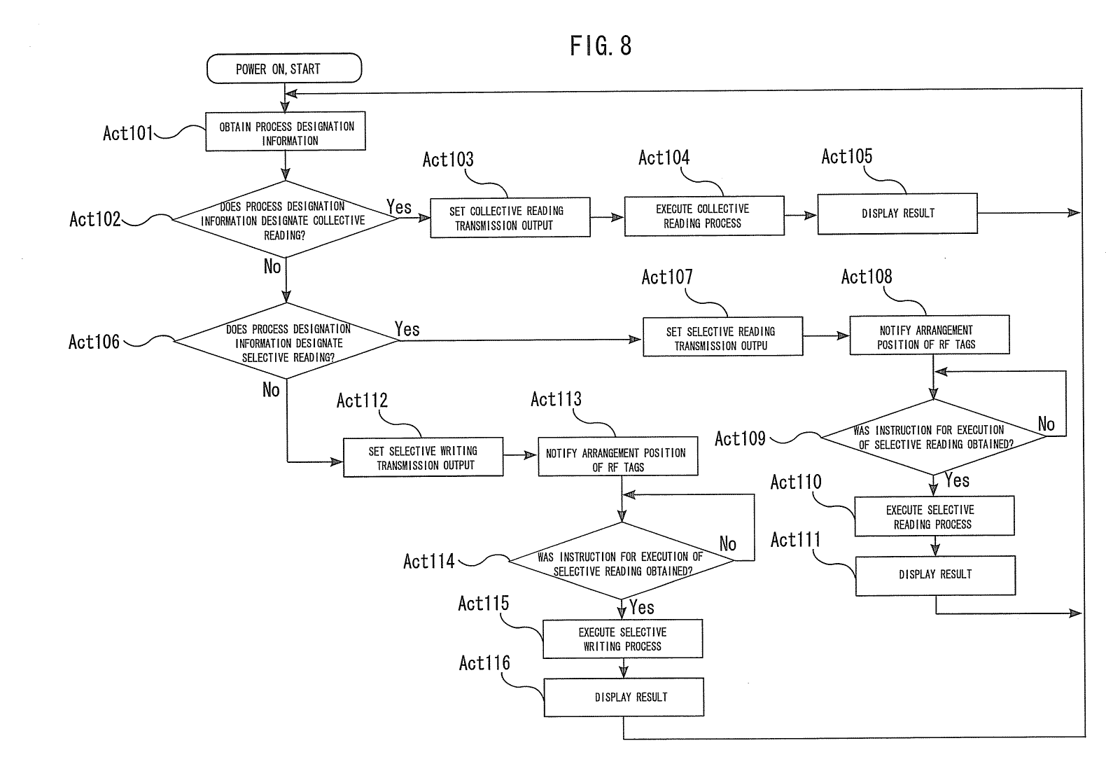

Next, a description will be made of the process flow for the communication with the RF tags relating to collective reading, selective reading, or selective writing by the reader and writer 100 of the first embodiment with reference to FIG. 8. In the following description, the magnitude of the transmission output for the respective processes (that is, which output information is to be based on when the transmission output control unit 315 controls the transmission output for the respective processes) and the number of the RF tags to be communicated with in selective communication are preset in the reader and writer main body 30.

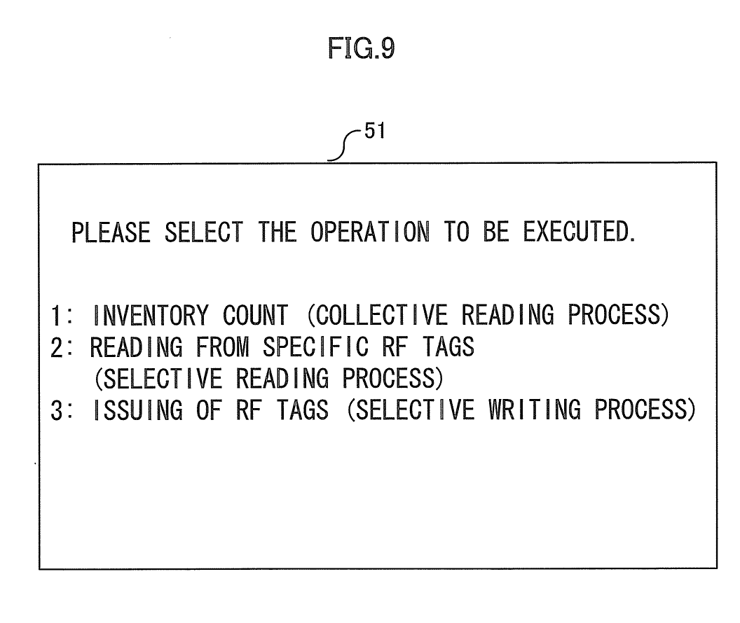

First, in Act 101, the control unit 31 obtains the process designation information indicating which process is to be executed from among collective reading, selective reading, and selective writing, based on input from the user. Specifically, the control unit 31 constructs a process designation screen 51 as shown in FIG. 9, and causes the display unit 37 to display the screen. The user designates a desired process via the input unit 35 based on the process designation screen 51 displayed on the display unit 37. The control unit 31 obtains the process designation information from the user's designation via the input unit 35.

Next, in Act 102, the control unit 31 determines whether the obtained process designation information designates collective reading. If the information designates collective reading, the transmission output control unit 315 of the control unit 31 sets the transmission output for the wireless unit 33 based on the collective reading output information stored in the storage unit 311 in Act 103.

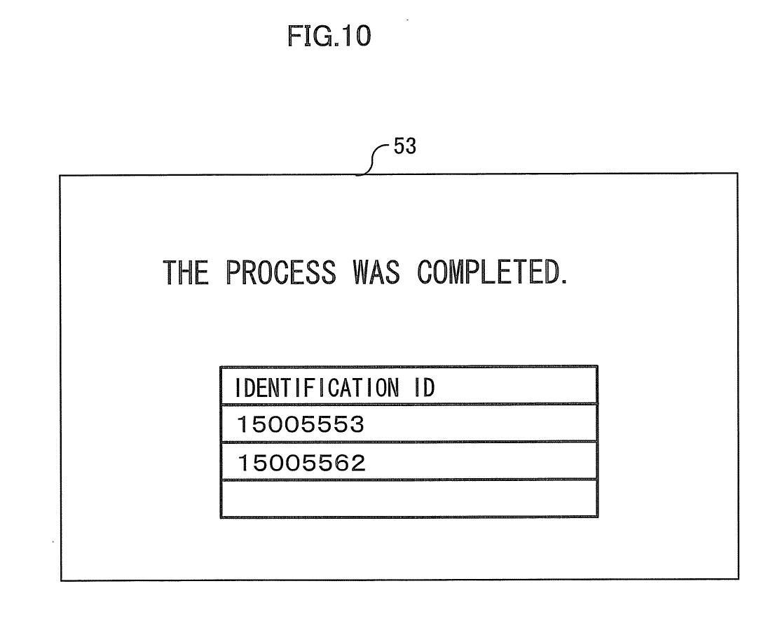

Next, in Act 104, the control unit 31 controls the wireless unit 33 to cause the antenna device 10 to radiate radio waves for collective reading, thereby performing collective reading, and obtains the information (identification ID) held in the RF tags. Then, in Act 105, the control unit 31 constructs a process result screen 53 (FIG. 10) for informing of the completion of the process and causes the display unit 37 to display the screen, and the process returns to Act 101. If the executed process is collective reading, described herein, or selective reading, which will be described later, the control unit 31 displays the obtained identification ID along with the notification of the completion of the process on the process result screen for the notification for the user. In addition, if the control unit 31 cannot obtain the identification ID, the control unit displays the notification of the failure of the communication with the RF tags instead of the content shown in FIG. 10 on the process result screen 53 for the notification for the user.

On the other hand, if it is determined that the process designation information does not designate collective reading in Act 102, the process proceeds to Act 106, and the control unit 31 determines whether the process designation information designates selective reading. If the information designates selective reading, the process proceeds to Act 107, and the transmission output setting unit of the control unit 31 sets the transmission output for the wireless unit 33 based on the selective reading output information stored in the storage unit 311.

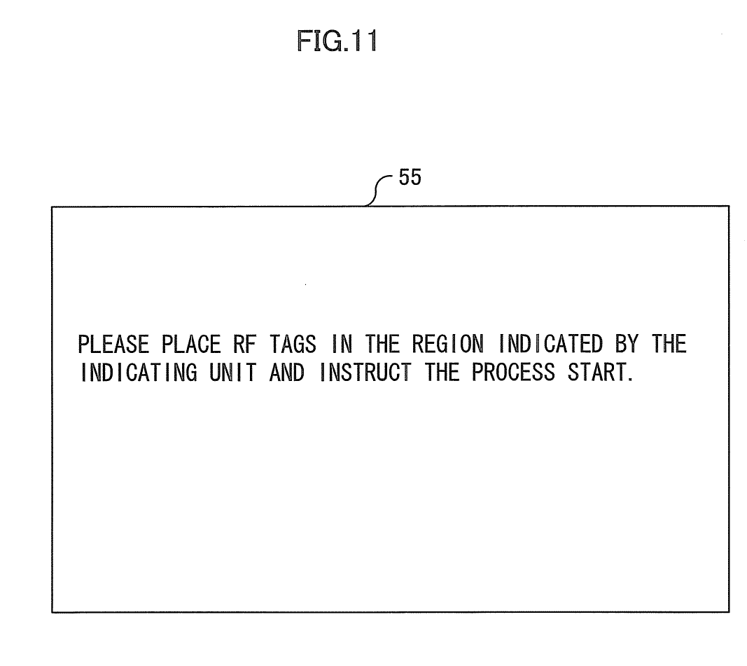

Next, in Act 108, the control unit 31 constructs a process start screen 55, as shown in FIG. 11, for encouraging the movement to the region in the respective RF tags, which is indicated by the indicating unit 16, and obtaining the user's instruction relating to the reading start, and causes the display unit 37 to display the process start screen 55. Then, the process proceeds to Act 109, and the control unit 31 determines whether the information regarding the reading start is obtained. If the user places the RF tag in the region on the antenna case body, which is indicated by the indicating unit 16 (inside the elliptical shape in this embodiment) and inputs the instruction for the reading start via the input unit 35, the control unit 31 obtains an instruction relating to the reading start, and the process proceeds to Act 110. In Act 110, the control unit 31 controls the wireless unit 33 to cause the antenna device 10 to radiate the radio wave for selective reading, performs the selective reading process, and obtains the identification ID held in the respective RF tags. Thereafter, in Act 111, the control unit 31 causes the display unit 37 to display the process result screen 53 for notifying the obtained identification ID along with the completion of the process (FIG. 10), and the process returns to Act 101.

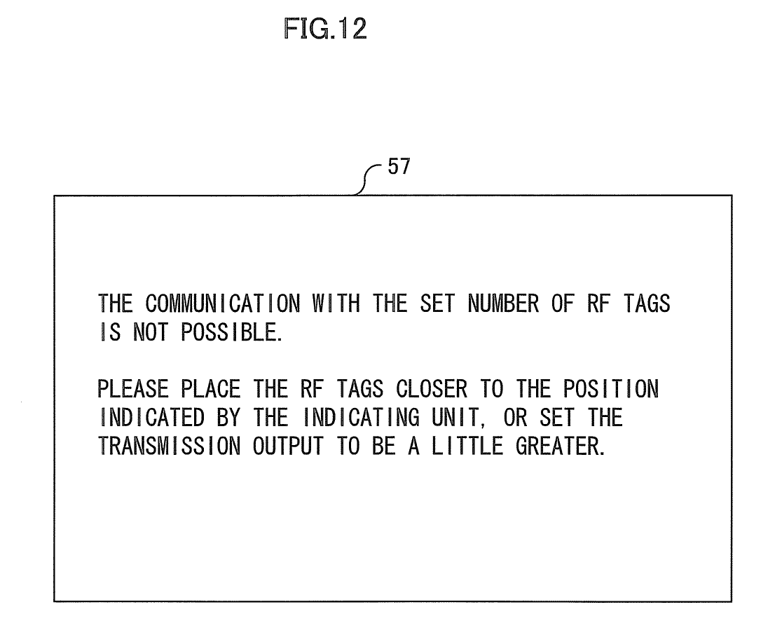

Here, the RF tags, of which the number is smaller or larger than that preset by the user, are read as a result of the execution of selective reading in some cases. At this time, if the RF tags of which the number was smaller than the set number were read, the control unit 31 constructs a process result screen 57 as shown in FIG. 12, causes the display unit 37 to display the screen, and encourages the user to move the RF tags or increase the setting of the transmission output.

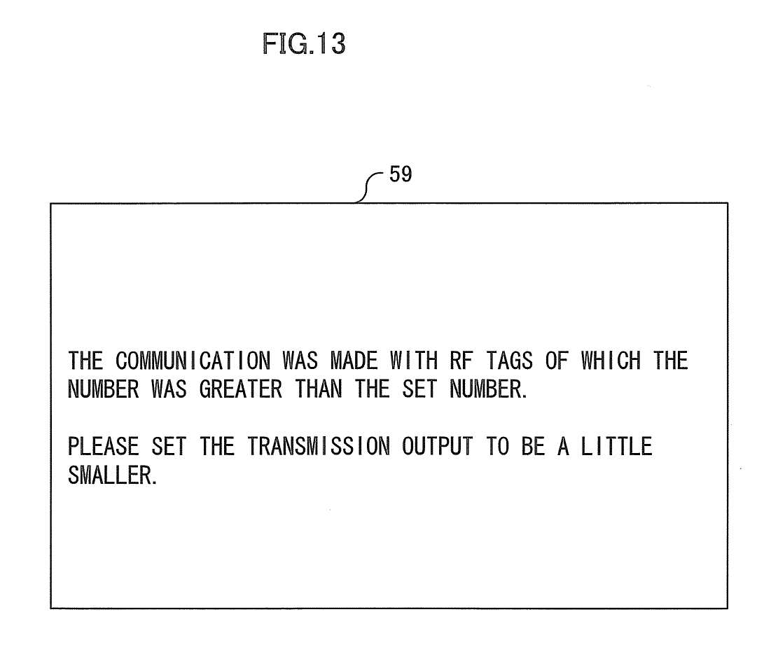

On the other hand, if the RF tags of which the number was larger than the set number were read, the control unit 31 constructs a process result screen 59 as shown in FIG. 13, causes the display unit 37 to display the screen, and encourages the user to decrease the setting of the transmission output.

In Act 106, if it is determined that the process designation information does not designate selective reading, the control unit 31 determines that the process designation information designates selective writing. Then, the process proceeds to Act 112, and the transmission output setting unit 315 of the control unit 31 sets the transmission output for the wireless unit 33 based on the selective reading output information stored in the storage unit 311.

Next, in Act 113, the control unit 31 constructs the process start screen as shown in FIG. 11 for encouraging the movement of the RF tags to the region indicated by the indicating unit 16 and obtaining the user's instruction regarding the reading start, and causes the display unit 37 to display the screen. Subsequently, the process proceeds to Act 114, and the control unit 31 determines whether or not the instruction for the reading start is obtained. If the user places the RF tags in the region on the antenna case body, which is indicated by the indicating unit 16, and inputs the reading start instruction via the input unit 35, the control unit 31 obtains the instruction for the reading start, and the process proceeds to Act 115. In Act 115, the control unit 31 controls the wireless unit 33 to cause the antenna device 10 to radiate the radio waves for selective writing, performs selective writing, and add the identification ID for the respective RF tags. Then, in Act 116, the control unit 31 confirms that the writing is completed based on the responses from the RF tags, constructs the process result screen 53 in the same manner as in the case of reading process, and causes the display unit 37 to display the screen.

Here, writing is performed on the RF tags, of which the number is smaller or larger than that preset by the user in the designation of the process designation information, as a result of the execution of selective writing in some cases. At this time, if writing was performed on RF tags of which the number was smaller than the preset number, the control unit 31 constructs the process result screen 57 as shown in FIG. 12, causes the display unit 37 to display the screen, and encourages the user to move the RF tags or increase the setting of the transmission output. On the other hand, if writing was performed on RF tags of which the number was larger than the preset number, the control unit 31 constructs the process result screen 59 as shown in FIG. 13, causes the display unit 37 to display the screen, and encourages the user to decrease the setting of the transmission output.

As described above, the reader and writer 100 of the first embodiment can perform both collective reading and selective communication by changing the transmission output of the radio wave to be radiated from the antenna device 10. In addition, it is possible to allow the region in which the field intensity is not less than the predetermined threshold value to correspond the region (the vicinity of the leading end of the slit provided in the radiation element) indicated by the indicating unit by controlling the transmission output. Accordingly, it is possible to reliably communicate with the RF tags, with which the user desires to communicate, in selective communication.

### Second Embodiment

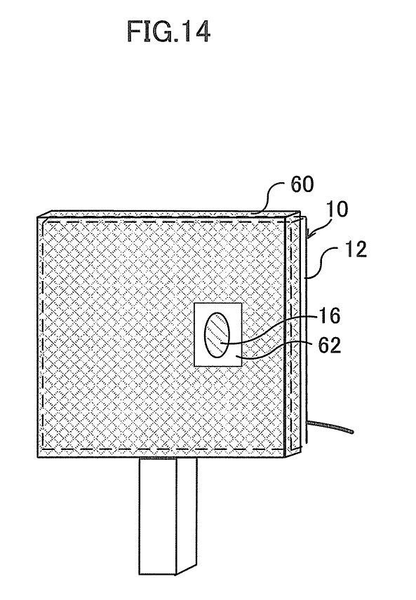

In the second embodiment, the reader and writer 100 further includes a restriction member 60 to be used by being mounted on the antenna device 10 as shown in FIG. 14 in addition to the configuration described in the first embodiment. It is possible to restrict the radiation of the radio waves from the region other than the region indicated by the indicating unit 16 to the outside of the case body as compared with the radiation of the radio wave from the region indicated by the indicating unit 16 to the outside of the case body, by mounting the restriction member 60 onto the antenna device 10. The restriction member 60 is configured of a metal material, for example, as shown in FIG. 14, and can be a compact provided with an opening portion 62 in the vicinity of the position indicated by the indicating unit 16. In addition, it is also possible to differently configure the restriction member 60. For example, the restriction member 60 can be a compact which has a surface facing the outer surface of the antenna case body in the mounted state and configured with plastic processed for radio wave absorption (attached with a radio wave absorption material, for example) as its material, and is provided with an opening portion only at a position corresponding to the vicinity of the position indicated by the indicating unit 16 or constituted by an unprocessed plastic.

In the second embodiment, the restriction member 60 is configured to be able to retreat from the position where the radiation of the radio wave from the region other then the region indicated by the indicating unit 16 to the outside of the case body 12 is restricted to the position where the radiation of the radio wave is not restricted, by being detached from the outer surface of the antenna device 10 (antenna case body 12). However, the retreat of the restriction member 60 from the antenna device 10 is not limited to detaching from the surface of the antenna case body, and can be configured differently. For example, it is also applicable to configure the restriction member 60 by connecting to the antenna case body 12 via a hinge and allow the restriction member 60 to be movable from a position where the radiation of the radio waves is restricted to a position where the radiation of the radio waves is not restricted (in this specification, “retreat” as a concept includes movement of position).

### Other Embodiments

Although the description was made of the first and second embodiments as above, it is needless to say that another configuration can be applied.

For example, although the radiation element 145 of the antenna device 10 has a rectangular shape in the first embodiment, the shape thereof is not particularly limited as long as it is a plate shape formed with a notch portion extending such that a part of the outer line of the radiation element 145 is recessed toward the center, and the radiation element 145 may be shaped differently. In such a case, the feeding point 44 is arranged at a position in the vicinity of the leading end of the notch portion 15 in which more current flows; in other words, the position in the vicinity of the leading end of the notch portion 15, in which the field intensity is allowed to be not less than the predetermined threshold value when the transmission output is adjusted.

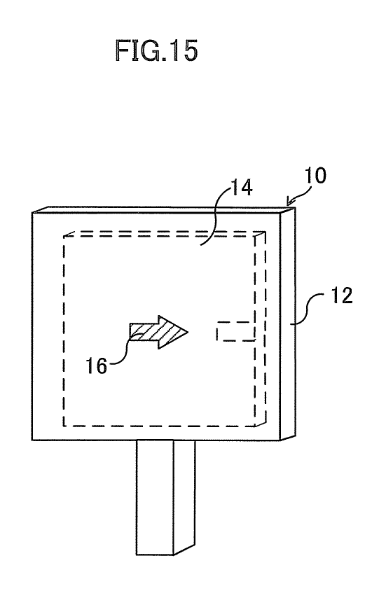

In addition, although the indicating unit 16 has an elliptical shape printed on the outer surface of the antenna case body 12 in the first embodiment, the shape thereof is not limited thereto. For example, it is also possible to provide the indicating unit 16 by forming a recess or a protrusion on the outer surface of the case body 12 or by attaching a sticker. In addition, the shape thereof is also not particularly limited, and can be an arrow shape as shown in FIG. 15, for example. In FIG. 15, a part indicated by the broken line is a position corresponding to the vicinity of the leading end of the notch portion 15. In this case, the indicating unit 16 is applicable as long as the field intensity is not less than the threshold value t in the region indicated by the arrow, and it is not necessary that the field intensity of the radio wave is not less than the threshold value in the region in the arrow itself.

Moreover, the output information for controlling the transmission output is stored in the storage unit 311 constituted by the ROM or the RAM in the reader and writer main body 30 in the first embodiment. However the invention is not limited thereto, and it is also applicable that the output information is stored in a storage unit in the external device and obtained by the control unit 31 via the interface unit 39, if necessary.

Furthermore, although the antenna device 10 (antenna case body 12) and the reader and writer main body 30 are separately configured in the first embodiment, it is also applicable to integrally configure the antenna device 10 and the reader and writer main body 30 by connecting two case bodies (antenna case body 12 and the case body of the reader and writer main body 30) or by accommodating the patch antenna 14 and the hardware of the reader and writer main body 30 in the respective compartment inside one case body.

Moreover, although the transmission output is set based on the output information stored in advance in the first embodiment, it is also applicable that the user sets the transmission output via the input unit 35.

As described above, according to the technique disclosed in this specification, it is possible to collectively communicate with one or a plurality of unspecified RF tags, and reliably communicate with one or a plurality of specific RF tags in selective communication.

While certain embodiments have been described, these embodiments have been presented by way of example only, and are not intended to limit the scope of invention. Indeed, the novel apparatus, methods and computer readable media described herein may be embodied in a variety of other forms; furthermore, various omissions, substitutions and changes in the form of the apparatus and methods and computer readable media described herein may be made without departing from the sprit of the inventions. The accompanying claims and their equivalents are intended to cover such forms or modifications as would fall within the scope and spirit of the inventions.

What is claimed is:

1. An antenna device for RF tag communication comprising:
a plate-shaped radiation element; and
an antenna case body which contains the radiation element and has an indicating unit at a position corresponding to a region in which the field intensity of the electric field generated at the radiation element is the highest.

2. The device according to claim 1,
wherein a notch portion with a predetermined shape is formed in the radiation element, and
wherein the region in which the field intensity of the electric field generated at the radiation element is the highest is a region corresponding to a predetermined position of the notch portion formed in the radiation element.

3. The device according to claim 1,
wherein the notch portion is a slit extending such that a part of the outer line of the radiation element is recessed toward the center thereof.

4. The device according to claim 3,
wherein the radiation element is a rectangular plate having a side with the notch portion, and supplied with a current via a feeding point located at a substantially central position in an extending direction of the notch portion on the plate and at a position which is different from a center position of the plate in a direction perpendicular to the extending direction of the notch portion on the plate.

5. An RF tag reader and writer comprising:
the antenna device for RF tag communication according to claim 1; and
a transmission output control unit for controlling a transmission output of radio waves radiated from the radiation element.

6. The RF tag reader and writer according to claim 5,
wherein the transmission output control unit can switch between a first output mode for radiating radio waves at a transmission output capable of communicating only with RF tags located in a region indicated by the indicating unit and a second output mode for radiating radio waves at a transmission output which is larger than the transmission output for the first output mode.

7. The RF tag reader and writer according to claim 5, further comprising:
a restriction member which restricts a radiation of radio waves from a region in the radiation element other than the region indicated by the indicating unit to the outside of the case body as compared with a radiation of radio waves from the region in the radiation element, which is indicated by the indicating unit, to the outside of the case body, and is capable of retreating from a position in which the radiation of the radio wave from the region other than the region indicated by the indicating unit to the outside of the case body to a position in which the radiation of the radio wave is not restricted.
